(19) United States
(12) Patent Application Publication
(10) Pub. No.: US 2014/0174735 A1
(43) Pub. Date: Jun. 26, 2014

(54) METHOD, SYSTEM, AND COMPOSITION FOR PRODUCING OIL

(71) Applicant: Shell Oil Company, Houston, TX (US)

(72) Inventors: Jeffrey George SOUTHWICK, Houston, TX (US); Yi SVEC, Katy, TX (US); Gordon Thomas SHAHIN, Bellaire, TX (US)

(73) Assignee: Shell Oil Company, Houston, TX (US)

(21) Appl. No.: 14/132,725

(22) Filed: Dec. 18, 2013

Related U.S. Application Data
(60) Provisional application No. 61/745,930, filed on Dec. 26, 2012.

(51) Int. Cl. C09K 8/588; E21B 43/16

(52) U.S. Cl. CPC C09K 8/588; E21B 43/16
USPC 166/270.1; 507/225

(57) ABSTRACT

A method, system, and composition for producing oil from a formation utilizing an oil recovery formulation comprising a surfactant, an ammonia liquid, a polymer, and water are provided.

This application claims priority from U.S. Provisional Application Ser. No. 61/745,930, filed Dec. 26, 2012, which is hereby incorporated by reference in its entirety.

### FIELD OF THE INVENTION

The present invention is directed to a method for producing oil from a formation, in particular, the present invention is directed to a method of enhanced oil recovery from a formation.

### BACKGROUND OF THE INVENTION

In the recovery of oil from a subterranean formation, it is possible to recover only a portion of the oil in the formation using primary recovery methods utilizing the natural formation pressure to produce the oil. A portion of the oil that cannot be produced from the formation using primary recovery methods may be produced by improved or enhanced oil recovery (EOR) methods.

One enhanced oil recovery method utilizes an alkaline-surfactant-polymer (“ASP”) flood in an oil-bearing formation to increase the amount of oil recovered from the formation. An aqueous dispersion of an alkali, a surfactant, and a polymer is injected into an oil-bearing formation to increase recovery of oil from the formation, either after primary recovery or after a secondary recovery waterflood. The ASP flood enhances recovery of oil from the formation by lowering interfacial tension between oil and water phases in the formation, thereby mobilizing the oil for production. Interfacial tension between the oil and water phases in the formation is reduced by the surfactant of the ASP flood and by the formation of soaps by alkali interaction with acids in the oil. The polymer increases the viscosity of the ASP fluid, typically to the same order of magnitude as the oil in the formation, so the mobilized oil may be forced through the formation for production by the ASP flood.

Use of ASP enhanced oil recovery to recover oil from subsea oil-bearing formations may be constrained by the amount of space available on an offshore oil recovery platform and by the weight limitations of the platform. Storage facilities must be provided for the polymer, the surfactant, and for the alkali. In some instances the offshore platform space and weight limitations preclude the use of ASP enhanced oil recovery since there is not enough room to store all of the components of the ASP flood on the platform or the weight of the components of the ASP flood is prohibitive for use on an offshore oil recovery platform.

Alkalis most commonly used as the alkali in ASP flood enhanced oil recovery processes include hydroxides and carbonates, and the most common alkali is sodium carbonate. Offshore oil recovery platform limitations on space and weight may render an alkali-carbonate ASP enhanced oil recovery process untenable for recovering oil from a subsea formation due to the relatively large storage space required for the alkali-carbonate storage, the large space required for mixing facilities, and the relatively heavy weight of the alkali-carbonate solution.

Furthermore, in oil-bearing formations containing a significant concentration of calcium ions dispersed in water and/or oil in the formation or dispersed along the surfaces of the formation, use of an alkali such as a carbonate in an ASP flood enhanced oil recovery process contributes to the build-up of scale in production well strings. Water-soluble alkalis used in an ASP flood such as sodium carbonate react with calcium from the formation water, oil, or surfaces to form calcium carbonate. Contact of the alkali carbonate of the ASP flood with calcium in the formation near the production well induces the formation of calcium carbonate, some of which precipitates and deposits as scale in the production well strings. When the calcium content of a formation is high, such scale deposition may require that the production string either be periodically treated to remove the scale or that the production string be periodically replaced.

Improvements to existing ASP enhanced oil recovery methods, compositions, and systems are desirable. In particular, methods, compositions, and systems effective to further enable utilization of ASP-based enhanced oil recovery in subsea oil-bearing formations and to inhibit the deposition of scale in production well strings during an ASP enhanced oil recovery process are desirable.

### SUMMARY OF THE INVENTION

In one aspect, the invention is directed to a process for recovering oil from an oil-bearing formation, comprising:

mixing a surfactant, water, a polymer, and ammonia liquid comprising at most 10 wt. % water to form an oil recovery formulation;

introducing the oil recovery formulation into the oil-bearing formation;

contacting the oil recovery formulation with oil in the oil-bearing formation; and

producing oil from the oil-bearing formation after introduction of the oil recovery formulation into the oil-bearing formation.

In another aspect, the invention is directed to a composition comprising a surfactant, a polymer, ammonia, and water.

In another aspect, the invention is directed to a system, comprising:

a surfactant;

a polymer;

an ammonia liquid comprising at most 10 wt. % water;

water;

an oil-bearing formation;

a mechanism for introducing the surfactant, the polymer, the ammonia liquid, and the water into the oil-bearing formation; and

a mechanism for producing oil from the oil-bearing formation subsequent to introduction of the surfactant, the polymer, the ammonia liquid, and the water into the oil-bearing formation.

In another aspect, the present invention is directed to a process for recovering oil from an oil-bearing formation, comprising:

introducing a surfactant, water, a polymer, and an ammonia liquid containing at most 10 wt. % water into the oil-bearing formation;

mixing the surfactant, water, polymer, and ammonia liquid in the oil-bearing formation to form an oil recovery formulation;

contacting the oil recovery formulation with oil in the oil-bearing formation; and

producing oil from the oil bearing-formation after introduction of the surfactant, water, polymer and ammonia liquid into the oil-bearing formation.

### BRIEF DESCRIPTION OF THE DRAWINGS

FIG. 1 is an illustration of a oil production system in accordance with the present invention that may be utilized to recover oil by a process in accordance with the present invention.

FIG. 2 is an illustration of an oil production system in accordance with the present invention that may be utilized to recover oil by a process in accordance with the present invention.

FIG. 3 is a diagram of a well pattern for production of oil in accordance with a system and process of the present invention.

FIG. 4 is a diagram of a well pattern for production of oil in accordance with a system and process of the present invention.

FIG. 5 is a graph of residual oil production as a function of addition of an ammonia-surfactant-polymer brine solution.

### DETAILED DESCRIPTION OF THE INVENTION

The present invention is directed to a method and system for enhanced oil recovery from an oil-bearing formation utilizing a surfactant, water, a polymer, an ammonia liquid comprising at most 10 wt. % water, and a composition comprising a surfactant, a polymer, ammonia, and water. The surfactant, water, polymer, and ammonia liquid may be mixed together to form an oil recovery formulation for use in the enhanced oil recovery process. The surfactant and the ammonia may mobilize the oil in the formation by reducing interfacial tension between oil and water in the formation, and the polymer may provide a viscosity sufficient to drive the mobilized oil through the formation for production from the formation.

Use of ammonia is favorable for reducing space and weight requirements of an ASP flood EOR process relative to conventionally used alkali-carbonate alkalis. For example, anhydrous liquid ammonia yields 6.2 times the alkalinity of an equivalent weight amount of sodium carbonate, so the weight requirement of the alkali component of an ASP flood system utilizing anhydrous liquid ammonia may be reduced by 6.2 times relative to sodium carbonate while providing the same relative alkalinity. Less space and weight, therefore, are required to store the ammonia alkali component of the ASP fllod system of the present invention relative to conventionally used alkali-carbonate alkalis since less must be used to provide equivalent levels of alkalinity. On an offshore platform used for recovery of oil from a subsea oil-bearing formation, space and weight savings provided by substituting liquid ammonia for conventionally used alkalis may be the determining factor of the feasibility of using an ASP EOR process on the platform.

Furthermore, use of ammonia in an ASP EOR process is much less likely to induce precipitation of calcium in the production well strings of the production well than conventionally utilized alkali carbonates. Calcium hydroxide, the calcium precipitate formed when utilizing liquid ammonia as the basic component in an ASP EOR process in accordance with the present invention, will only precipitate at Ca²⁺ concentrations above 8.8% at 25° C.—which is above the Ca²⁺ concentration in most oil-bearing formations. Calcium carbonate, the calcium precipitate formed when utilizing conventional alkali carbonates as the alkali in an ASP EOR process, however, will precipitate at Ca²⁺ concentrations on the order of

3×10⁻⁷%. Therefore, use of ammonia in the ASP EOR process of the present invention will precipitate significantly less calcium than conventional alkali carbonates, and may significantly inhibit the development of scale in the production well strings of a production well relative to conventional alkali carbonates.

The oil recovery formulation composition of the present invention that may be used in the method or system of the present invention is comprised of a surfactant, a polymer, ammonia, and water. The water may be fresh water or a brine solution. The water may have a total dissolved solids (TDS) content of from 100 ppm to 200000 ppm. The water may be provided from a water source, where the water source may be a fresh water source having a TDS content of less than 10000 ppm selected from the group consisting of a river, a lake, a fresh water sea, an aquifier, and formation water having a TDS content of less than 10000 ppm, or the water source may be a saline water source having a TDS content of 10000 ppm or greater selected from the group consisting of seawater, brackish water, an aquifer, a brine solution provided by processing a saline water source, and formation water having a TDS content of 10000 ppm or greater.

When the ASP EOR process utilizing the oil recovery formulation is conducted offshore to recover oil from a subsea oil-bearing formation, the water may be seawater treated to reduce the salinity of the seawater to a desired TDS content. The salinity of the seawater may be reduced by conventional desalination processes, for example, by passing the seawater through one or more nanofiltration, reverse osmosis, and/or forward osmosis membranes.

The TDS content of the oil recovery formulation water may be adjusted to optimize the salinity of the water for the production of a middle phase, type III, microemulsion of the surfactant and ammonia of the oil recovery formulation with oil and formation water in the formation and thereby minimize interfacial tension between oil and water in the formation to maximize mobilization, and therefore, production, of the oil from the formation. The TDS content of the oil recovery formulation water may also be adjusted to optimize the viscosity of the oil recovery formulation, since the viscosity of the oil recovery formulation is dependent in part on the viscosity of the polymer in the formulation, which may be dependent on the salinity of the formulation. Determination of the optimum salinity of the oil recovery formulation water for minimizing interfacial tension of the oil and water in the oil-bearing formation and for providing a viscosity on the same order of magnitude as the oil in the formation may be conducted according to methods conventional and known to those skilled in the art. One such method is described in WO Pub. No. 2011/090921. Salinity optimization of the water may be conducted in accordance with methods conventional and known to those skilled in the art, for example, salt concentrations may be decreased by ionic filtration using one or more nanofiltration membrane units, one or more reverse osmosis membrane units, and/or one or more forward osmosis membrane units; salt concentrations may be increased by adding one or more salts, preferably NaCl, to the water; and salt concentrations may be increased or decreased blending of the resulting permeates and retentates of ionic filtration to provide optimum salinity.

The oil recovery formulation may also be comprised of a co-solvent with water, where the co-solvent may be a low molecular weight alcohol including, but not limited to, methanol, ethanol, and propanol, isobutyl alcohol, secondary butyl alcohol, n-butyl alcohol, t-butyl alcohol, or a glycol including, but not limited to, ethylene glycol, 1,3-propanediol, 1,2-propandiol, diethylene glycol butyl ether, triethylene glycol butyl ether, or a sulfosuccinate including, but not limited to, sodium dihexyl sulfosuccinate. The co-solvent may be utilized for the purpose of adjusting the salinity of the oil recovery formulation fluid to optimize the salinity of the fluid for maximum reduction of interfacial tension between oil and water in the formation, and, optionally, for assisting in prevention of formation of a viscous emulsion upon conducting the EOR process. If present, the co-solvent may comprise from 100 ppm to 50000 ppm, or from 500 ppm to 5000 ppm of the oil recovery formulation. A co-solvent may be absent from the oil recovery formulation.

The oil recovery formulation further comprises ammonia, where the ammonia may interact with oil in the formation to form a soap effective to reduce the interfacial tension between oil and water in the formation. The ammonia may also reduce surfactant adsorption on the reservoir rock surfaces. An ammonia liquid may be mixed with other components of the enhanced oil recovery formulation to form the enhanced oil recovery formulation, where the ammonia liquid may be mixed with the other enhanced oil recovery formulation components prior to introduction of the enhanced oil recovery formulation to the oil-bearing formation or after one or more of the enhanced oil recovery formulation components have been individually introduced into the formation. The ammonia liquid mixed with the other components of the oil recovery formulation to form the oil recovery formulation utilized in the ASP EOR process and system of the present invention, and to form the composition of the present invention, is an ammonia liquid comprising at most 10 wt. % water, or at most 5 wt. % water, or at most 1 wt. % water and at least 90 wt. % ammonia. Most preferably, the ammonia liquid is anhydrous liquid ammonia to minimize the weight and space requirements for storing and utilizing the liquid ammonia in the ASP EOR process and system of the present invention.

The ammonia liquid is mixed with the other components of the oil recovery formulation, or is present in the oil recovery formulation, in an amount to provide the oil recovery formulation with a pH of at least 10. The ammonia liquid mixed with the other components of the oil recovery formulation, or the ammonia present in the oil recovery formulation, may provide relatively highly buffered alkalinity to the oil recovery formulation due to ammonia's dissociation constant, enabling the oil recovery formulation to have a relatively low but useful pH for an alkaline solution used in an ASP EOR process. A relatively low alkaline pH ASP oil recovery formulation may be desirable for use in certain oil-bearing formations to prevent dissolution of formation minerals by strong alkalinity—for example, formations containing significant quantities of silica quartz. Furthermore, the relatively highly buffered alkalinity provided to the oil recovery formulation by the ammonia may decrease the time required and the amount of oil recovery formulation required for the oil recovery formulation to breakthrough from an injection well to a production well in the ASP EOR process of the present invention; alkalis that are not highly buffered react with the formation, increasing the amount oil recovery formulation and time required for the oil recovery formulation to breakthrough from an injection well to a production well. Preferably the ammonia liquid is mixed with the other components of the oil recovery formulation, or is present in the oil recovery formulation, in an amount sufficient to provide the oil recovery formulation with an initial pH of from 10 to 12. The ammonia liquid may be mixed with the other components of the oil recovery formulation, or may be present in the oil recovery formulation, in an amount to provide ammonia in a concentration in the oil recovery formulation of from 0.01 M to 2 M, or from 0.1 M to 1 M.

The oil recovery formulation further comprises a surfactant, where the surfactant may be any surfactant effective to reduce the interfacial tension between oil and water in the oil-bearing formation and thereby mobilize the oil for production from the formation. The oil recovery formulation may comprise one or more surfactants. The surfactant may be an anionic surfactant. The anionic surfactant may be a sulfonate-containing compound, a sulfate-containing compound, a carboxylate compound, a phosphate compound, or a blend thereof. The anionic surfactant may be an alpha olefin sulfonate compound, an internal olefin sulfonate compound, a branched alkyl benzene sulfonate compound, a propylene oxide sulfate compound, an ethylene oxide sulfate compound, a propylene oxide-ethylene oxide sulfate compound, or a blend thereof. The anionic surfactant may contain from 12 to 28 carbons, or from 12 to 20 carbons. The surfactant of the oil recovery formulation may comprise an internal olefin sulfonate compound containing from 15 to 18 carbons or a propylene oxide sulfate compound containing from 12 to 15 carbons, or a blend thereof, where the blend contains a volume ratio of the propylene oxide sulfate to the internal olefin sulfonate compound of from 1:1 to 10:1.

The oil recovery formulation may contain an amount of the surfactant effective to reduce the interfacial tension between oil and water in the formation and thereby mobilize the oil for production from the formation. The oil recovery formation may contain from 0.05 wt. % to 5 wt. % of the surfactant or combination of surfactants, or may contain from 0.1 wt. % to 3 wt. % of the surfactant or combination of surfactants.

The oil recovery formulation further comprises a polymer, where the polymer may provide the oil recovery formulation with a viscosity on the same order of magnitude as the viscosity of oil in the formation under formation temperature conditions so the oil recovery formulation may drive mobilized oil across the formation for production from the formation with a minimum of fingering of the oil through the oil recovery formulation and/or fingering of the oil recovery formulation through the oil. The oil recovery formulation may comprise a polymer selected from the group consisting of polyacrylamides, partially hydrolyzed polyacrylamides, polyacrylates, ethylenic co-polymers, biopolymers, carboxymethylcelloluses, polyvinyl alcohols, polystyrene sulfonates, polyvinylpyrrolidones, AMPS (2-acrylamide-methyl propane sulfonate), and combinations thereof. Examples of ethylenic co-polymers include co-polymers of acrylic acid and acrylamide, acrylic acid and lauryl acrylate, and lauryl acrylate and acrylamide. Examples of biopolymers include xanthan gum and guar gum.

The quantity of polymer in the oil recovery formulation should be sufficient to provide the oil recovery formulation with a viscosity sufficient to drive the oil through the oil-bearing formation with a minimum of mobilized oil fingering through the oil recovery formulation and, optionally, a minimum of fingering of the oil recovery formulation through the mobilized oil. The quantity of the polymer in the oil recovery formulation may be sufficient to provide the oil recovery formulation with a dynamic viscosity at formation temperatures on the same order of magnitude, or, less preferably a greater order of magnitude, as the dynamic viscosity of the oil in the oil-bearing formation at formation temperatures so the oil recovery formulation may push the oil through the formation. In a preferred embodiment, the oil recovery formulation may have a dynamic viscosity within 400%, or within 300%, or within 200% of the dynamic viscosity of the oil in the oil-bearing formation when measured isothermally. The quantity of the polymer in the oil recovery formulation may be sufficient to provide the oil recovery formulation with a dynamic viscosity of at least 1 mPa s (1 cP), or at least 10 mPa s (10 cP), or at least 50 mPa s (50 cP), or at least 100 mPa s (100 cP) at 25° C. or at a temperature within a formation temperature range. The concentration of polymer in the oil recovery formulation may be from 200 ppm to 5000 ppm, or from 500 ppm to 2500 ppm, or from 1000 to 10000 ppm.

The molecular weight average of the polymer in the oil recovery formulation should be sufficient to provide sufficient viscosity to the oil recovery formulation to drive the mobilized oil through the formation. The polymer may have a molecular weight average of from 10,000 to 30,000,000 daltons, or from 100,000 to 10,000,000 daltons.

In one aspect, the present invention is directed to an oil recovery formulation composition comprising water, ammonia, a surfactant, and a polymer. The water, ammonia, surfactant, and polymer may be as described above. The oil recovery formulation composition may contain an amount of ammonia liquid comprising at most 10 wt. % water, preferably anhydrous liquid ammonia, in an amount effective to provide the oil recovery formulation with an initial pH of from 10 to 12, or an ammonia concentration of from 0.01 M to 2 M; from 0.05 wt. % to 5 wt. %, or from 0.1 wt. % to 3 wt. % of the surfactant or combination of surfactants; and from 250 ppm to 5000 ppm, or from 500 ppm to 2500 ppm, or from 1000 to 2000 ppm of the polymer or a combination of polymers.

In the method of the present invention, the oil recovery formulation is, or components of the oil recovery formulation are, introduced into an oil-bearing formation, and the system of the present invention includes an oil-bearing formation. The oil-bearing formation comprises oil that may be separated and produced from the formation after contact and mixing with the oil recovery formulation. The oil of the oil-bearing formation may contain oil having a total acid number (TAN) expressed in milligrams of KOH per gram of sample of at least 0.3 or at least 0.5 or at least 1, wherein the TAN of an oil may be determined in accordance with ASTM Method D664. Oils having a TAN of at least 0.3 contain significant quantities of acidic moieties that may interact with ammonia to form a soap when treated with an oil recovery formulation comprising ammonia, thereby reducing interfacial tension between oil and water in the formation and mobilizing the oil for production from the formation.

The oil contained in the oil-bearing formation may be a light oil or an intermediate weight oil containing less than 25 wt. %, or less than 20 wt. %, or less than 15 wt. %, or less than 10 wt. %, or less than 5 wt. % of hydrocarbons having a boiling point of at least 538° C. (1000° F.) and having an API gravity as determined in accordance with ASTM Method D6882 of at least 20°, or at least 25°, or at least 30°. Alternatively, but less preferably, the oil of the oil bearing-formation may be a heavy oil containing more than 25 wt. % of hydrocarbons having a boiling point of at least 538° C. and having an API gravity of less than 20°.

The oil contained in the oil-bearing formation may have a dynamic viscosity under formation conditions (in particular, at temperatures within the temperature range of the formation) of at least 0.4 mPa s (0.4 cP), or at least 10 mPa s (10 cP), or at least 100 mPa s (100 cP), or at least 1000 mPa s (1000 cP), or at least 10000 mPa s (10000 cP). The oil contained in the oil-bearing formation may have a dynamic viscosity under formation temperature conditions of from 0.4 to 10000000 mPa s (0.4 to 10000000 cP).

The oil-bearing formation may be a subterranean formation. The subterranean formation may be comprised of one or more porous matrix materials selected from the group consisting of a porous mineral matrix, a porous rock matrix, and a combination of a porous mineral matrix and a porous rock matrix, where the porous matrix material may be located beneath an overburden at a depth ranging from 50 meters to 6000 meters, or from 100 meters to 4000 meters, or from 200 meters to 2000 meters under the earth's surface.

The subterranean formation may be a subsea subterranean formation. The method and system of the present invention may be particularly suited for recovering oil from an oil-bearing subsea subterranean formation utilizing an offshore oil recovery platform.

The porous matrix material may be a consolidated matrix material in which at least a majority, and preferably substantially all, of the rock and/or mineral that forms the matrix material is consolidated such that the rock and/or mineral forms a mass in which substantially all of the rock and/or mineral is immobile when oil, the oil recovery formulation, water, or other fluid is passed therethrough. Preferably at least 95 wt. % or at least 97 wt. %, or at least 99 wt. % of the rock and/or mineral is immobile when oil, the oil recovery formulation, water, or other fluid is passed therethrough so that any amount of rock or mineral material dislodged by the passage of the oil, oil recovery formulation, water, or other fluid is insufficient to render the formation impermeable to the flow of the oil recovery formulation, oil, water, or other fluid through the formation. The porous matrix material may be an unconsolidated matrix material in which at least a majority, or substantially all, of the rock and/or mineral that forms the matrix material is unconsolidated. The formation may have a permeability of from 0.0001 to 15 Darcies, or from 0.001 to 1 Darcy. The rock and/or mineral porous matrix material of the formation may be comprised of sandstone and/or a carbonate selected from dolomite, limestone, and mixtures thereof—where the limestone may be microcrystalline or crystalline limestone and/or chalk. The rock and/or mineral porous matrix material of the formation may include significant quantities of silica quartz since the alkalinity of the ammonia based oil recovery formulation may be sufficiently low to avoid dissolution of the silica-quartz.

Oil in the oil-bearing formation may be located in pores within the porous matrix material of the formation. The oil in the oil-bearing formation may be immobilized in the pores within the porous matrix material of the formation, for example, by capillary forces, by interaction of the oil with the pore surfaces, by the viscosity of the oil, or by interfacial tension between the oil and water in the formation.

The oil-bearing formation may also be comprised of water, which may be located in pores within the porous matrix material. The water in the formation may be connate water, water from a secondary or tertiary oil recovery process water-flood, or a mixture thereof. The water in the oil-bearing formation may be positioned in the formation to immobilize oil within the pores. Contact of the oil recovery formulation with the oil and water in the formation may mobilize the oil in the formation for production and recovery from the formation by freeing at least a portion of the oil from pores within the formation by reducing interfacial tension between water and oil in the formation.

In some embodiments, the oil-bearing formation may comprise unconsolidated sand and water. The oil-bearing formation may be an oil sand formation. In some embodiments, the oil may comprise between about 1 wt. % and about 16 wt. % of the oil/sand/water mixture, the sand may comprise between about 80 wt. % and about 85 wt. % of the oil/sand/water mixture, and the water may comprise between about 1 wt. % and about 16 wt. % of the oil/sand water mixture. The sand may be coated with a layer of water with the petroleum being located in the void space around the wetted sand grains. Optionally, the oil-bearing formation may also include a gas, such as methane or air, for example.

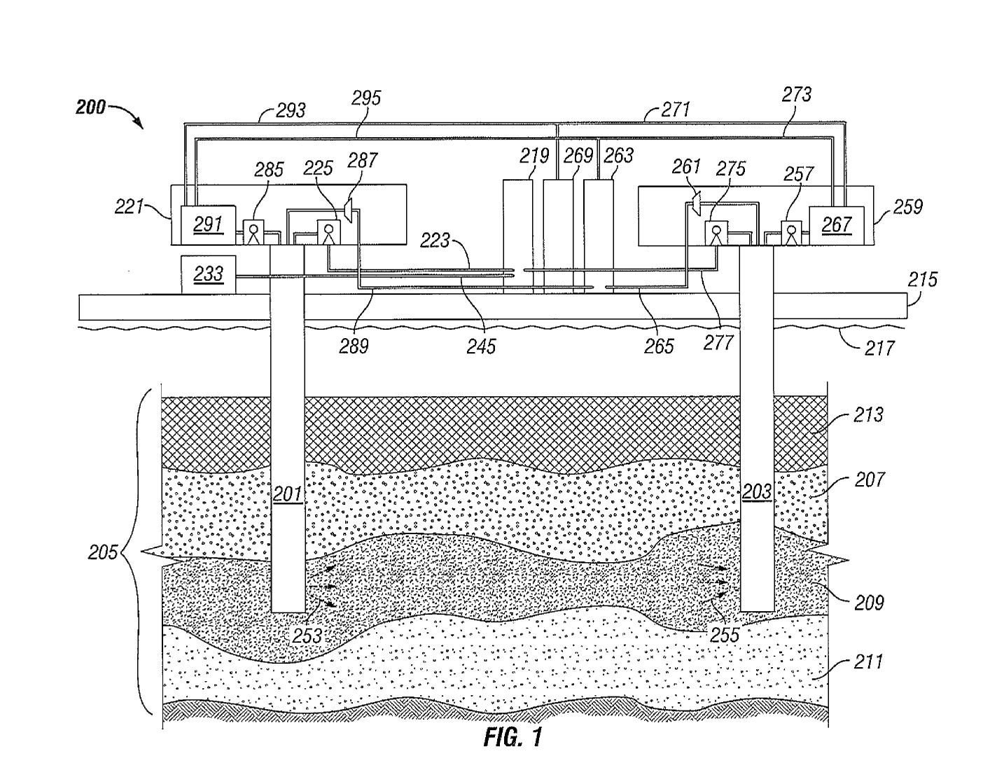

Referring now to FIG. 1, a system 200 of the present invention for practicing a method of the present invention is shown. The system includes a first well 201 and a second well 203 extending into an oil-bearing formation 205 such as described above. The oil-bearing formation 205 may be comprised of one or more formation portions 207, 209, and 211 formed of porous material matricies, such as described above, located beneath an overburden 213. The oil-bearing formation 205 may be a subsea formation where the first well 201 and the second well 203 may extend from one or more offshore platforms 215 located on the surface of the sea 217 above the oil-bearing formation 205.

In an embodiment, the system includes an oil recovery formulation comprising water as described above, ammonia as described above, a surfactant as described above, and a polymer as described above. The salinity of the oil recovery formulation may be selected and/or adjusted to optimize the interfacial tension reducing capacity of the surfactant and/or the ammonia of the oil recovery formulation with oil in the oil-bearing formation, and/or to optimize the viscosity of the oil recovery formulation, as described above. The oil recovery formulation may be provided from an oil recovery formulation storage facility 219 fluidly operatively coupled to a first injection/production facility 221 via conduit 223. First injection/production facility 221 may be fluidly operatively coupled to the first well 201, which may be located extending from the first injection/production facility 221 into the oil-bearing formation 205. The oil recovery formulation may flow from the first injection/production facility 221 through the first well 201 to be introduced into the formation 205, for example in formation portion 209, where the first injection/production facility 221 and the first well, or the first well itself, include(s) a mechanism for introducing the oil recovery formulation into the formation. Alternatively, the oil recovery formulation may flow from the oil recovery formulation storage facility 219 directly to the first well 201 for injection into the formation 205, where the first well comprises a mechanism for introducing the oil recovery formulation into the formation. The mechanism for introducing the oil recovery formulation into the formation 205 via the first well 201—located in the first injection/production facility 221, the first well 201, or both—may be comprised of a pump 225 for delivering the oil recovery formulation to perforations or openings in the first well through which the oil recovery formulation may be introduced into the formation.

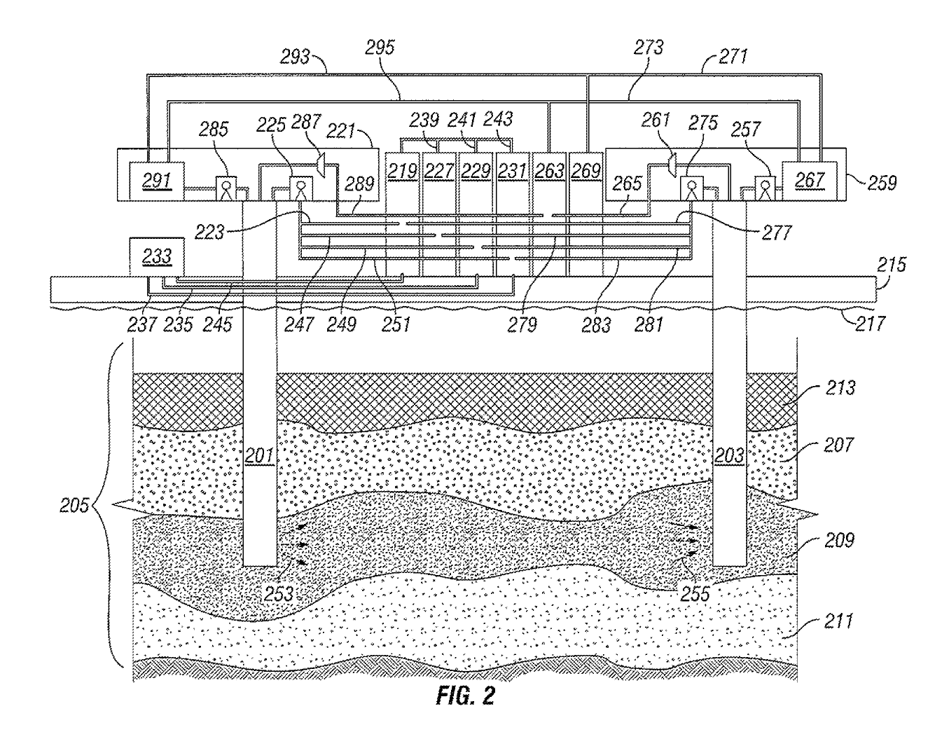

In another embodiment as shown in FIG. 2, the system may include separate storage facilities for one or more of the ammonia liquid, surfactant, and polymer of the enhanced oil recovery formulation. The ammonia liquid may be stored in an ammonia liquid storage facility 227, and may contain up to 10 wt. % water, or up to 5 wt. % water, or may be anhydrous liquid ammonia. The surfactant may be stored in a surfactant storage facility 229, and may be an anionic surfactant as described above. The polymer may be stored in a polymer storage facility 231, and may be a polymer as described above.

Water may be provided from source water—for example sea water, produced formation water, lake water, aquifer water, or river water—treated in a water treatment facility 233 to adjust the salinity of the water to an optimum salinity for use in the oil recovery formulation as described above. The water treatment facility may be operatively fluidly coupled to the surfactant storage facility 229 via conduit 235 to provide water for mixing with the surfactant to form a solution of the surfactant, and/or may be operatively fluidly coupled to the polymer storage facility 231 via conduit 237 to provide water for mixing with the polymer to form a solution of the polymer. Alternatively, the surfactant stored in the surfactant storage facility 229 may be a pre-mixed aqueous surfactant solution and/or the polymer stored in the polymer storage facility 231 may be a pre-mixed aqueous polymer solution.

The ammonia liquid, surfactant, and polymer may be provided from the ammonia liquid storage facility 225, the surfactant storage facility 229, and the polymer storage facility 231, respectively, to the oil recovery formulation storage facility 219 wherein the ammonia liquid, the surfactant, and the polymer may be mixed and stored as the oil recovery formulation. The ammonia liquid storage facility 225 may be operatively fluidly coupled to the oil recovery formulation storage facility 219 by conduit 239; the surfactant storage facility 229 may be operatively fluidly coupled to the oil recovery formulation storage facility by conduit 241; and the polymer storage facility 231 may be operatively fluidly coupled to the oil recovery formulation storage facility by conduit 243. Water for the oil recovery formulation, if necessary, may be provided from source water treated in the water treatment facility 233, wherein the water treatment facility may be operatively fluidly coupled to the oil recovery formulation storage facility 219 by conduit 245.

The oil recovery formulation may be provided from the oil recovery formulation storage facility 219 to the first injection/production facility 221 or to the first well 201 for injection into the formation 205 as described above.

Alternatively, the ammonia liquid, the surfactant, and the polymer may be provided separately from the ammonia liquid storage facility 225, the surfactant storage facility 229, and the polymer storage facility 231, respectively, to the first injection/production facility 221 or to the first well 201 for injection into the formation 205. The ammonia liquid storage facility 225 may be fluidly operatively coupled to the first injection/production facility 221 or the first well 201 by conduit 247; the surfactant storage facility 229 may be fluidly operatively coupled to the first injection/production facility or the first well by conduit 249; and the polymer storage facility 231 may be fluidly operatively coupled to the first injection/production facility or the first well by conduit 251. Ammonia liquid, surfactant, and/or polymer provided separately, and optionally additional water, may be mixed in the first injection/production facility 221 or the first well 201 to form the oil recovery formulation for injection into the formation. Alternatively the ammonia liquid, surfactant, polymer, and optionally additional water may be injected into the formation 205 via the first well 201 separately or in a combination that does not form the complete oil recovery formulation, and the ammonia liquid, surfactant, polymer, and optionally water, may be mixed to form the oil recovery formulation within the formation, where the oil recovery formulation formed within the formation may then be contacted with oil in the formation to mobilize the oil for production from the formation.

Referring now to both FIGS. 1 and 2, the oil recovery formulation may be introduced into the formation 205, for example by injecting the oil recovery formulation into the formation through the first well 201 by pumping the oil recovery formulation through the first well and into the formation, or by pumping the components of the oil recovery formulation through the first well into the formation for mixing within the formation to form the oil recovery formulation in situ. The pressure at which the oil recovery formulation or the components of the oil recovery formulation is/are introduced into the formation may range from the instantaneous pressure in the formation up to, but not including, the fracture pressure of the formation. The pressure at which the oil recovery formulation or its components may be injected into the formation may range from 20% to 95%, or from 40% to 90%, of the fracture pressure of the formation. Alternatively, the oil recovery formulation or its components may be injected into the formation at a pressure equal to, or greater than, the fracture pressure of the formation.

The volume of oil recovery formulation or combined components of the oil recovery formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil recovery formulation or combined components of the oil recovery formulation between the first well 201 and the second well 203. The pore volume may be readily be determined by methods known to a person skilled in the art, for example by modelling studies or by injecting water having a tracer contained therein through the formation 205 from the first well 201 to the second well 203.

As the oil recovery formulation is introduced into the formation 205 or as the components of the oil recovery formulation are individually introduced into the formation and mixed therein to form the oil recovery formulation, the oil recovery formulation spreads into the formation as shown by arrows 253. Upon introduction to the formation 205 or upon mixing of components of the oil recovery formulation in the formation to form the oil recovery formulation, the oil recovery formulation contacts and forms a mixture with a portion of the oil in the formation. The oil recovery formulation may mobilize the oil in the formation upon contacting and mixing with the oil and water in the formation. The oil recovery formulation may mobilize the oil in the formation upon contacting and mixing with the oil, for example, by reducing capillary forces retaining the oil in pores in the formation, by reducing the wettability of the oil on pore surfaces in the formation, by reducing the interfacial tension between oil and water in the formation, and/or by forming a microemulsion with oil and water in the formation.

The mobilized mixture of the oil recovery formulation and oil and water may be pushed across the formation 205 from the first well 201 to the second well 203 by further introduction of more oil recovery formulation or components of the oil recovery formulation into the formation. The oil recovery formulation may be designed to displace the mobilized mixture of the oil recovery formulation and oil through the formation 205 for production at the second well 203. As described above, the oil recovery formulation contains a polymer, wherein the oil recovery formulation comprising the polymer may be designed to have a viscosity on the same order of magnitude as the viscosity of the oil in the formation under formation temperature conditions, so the oil recovery formulation may drive the mobilized mixture of oil recovery formulation, oil, and water across the formation while inhibiting fingering of the mixture of mobilized oil and oil recovery formulation through the driving plug of oil recovery formulation and inhibiting fingering of the driving plug of oil recovery formulation through the mixture of mobilized oil and oil recovery formulation.

Oil may be mobilized for production from the formation 205 via the second well 203 by introduction of the oil recovery formulation and/or its components into the formation, where the mobilized oil is driven through the formation for production from the second well as indicated by arrows 255 by introduction of the oil recovery formulation or components of the oil recovery formulation into the formation via the first well 201. The oil mobilized for production from the formation 205 may include the mobilized oil/oil recovery formulation mixture. Water and/or gas may also be mobilized for production from the formation 205 via the second well 203 by introduction of the oil recovery formulation or its components into the formation via the first well 201.

After introduction of the oil recovery formulation into the formation 205 via the first well 201, oil may be recovered and produced from the formation via the second well 203. The system of the present invention may include a mechanism located at the second well for recovering and producing the oil from the formation 205 subsequent to introduction of the oil recovery formulation or the components of the oil recovery formulation into the formation, and may include a mechanism located at the second well for recovering and producing the oil recovery formulation, water, and/or gas from the formation subsequent to introduction of the oil recovery formulation into the formation. The mechanism located at the second well 203 for recovering and producing the oil, and optionally for recovering and producing the oil recovery formulation, water, and/or gas may be comprised of a pump 257, which may be located in a second injection/production facility 259 and/or within the second well 203. The pump 257 may draw the oil, and optionally the oil recovery formulation, water, and/or gas from the formation 205 through perforations in the second well 203 to deliver the oil, and optionally the oil recovery formulation, water, and/or gas, to the second injection/production facility 259.

Alternatively, the mechanism for recovering and producing the oil—and optionally the oil recovery formulation, water, and/or gas—from the formation 205 may be comprised of a compressor 261 that may be located in the second injection/production facility 259. The compressor 261 may be fluidly operatively coupled to a gas storage tank 263 via conduit 265, and may compress gas from the gas storage tank for injection into the formation 205 through the second well 203. The compressor may compress the gas to a pressure sufficient to drive production of oil—and optionally the oil recovery formulation, water, and/or gas—from the formation via the second well 203, where the appropriate pressure may be determined by conventional methods known to those skilled in the art. The compressed gas may be injected into the formation from a different position on the second well 203 than the well position at which the oil—and optionally the oil recovery formulation, water, and/or gas—are produced from the formation, for example, the compressed gas may be injected into the formation at formation portion 207 while oil, oil recovery formulation, water, and/or gas are produced from the formation at formation portion 209.

Oil, optionally in a mixture with the oil recovery formulation, water, and/or gas may be drawn from the formation 205 as shown by arrows 255 and produced up the second well 203 to the second injection/production facility 259. The oil may be separated from the oil recovery formulation, water, and/or gas in a separation unit 267 located in the second injection/production facility 259 and operatively fluidly coupled to the mechanism 257 for producing oil and, optionally, the oil recovery formulation, water, and/or gas, from the formation. The separation unit 267 may be comprised of a conventional liquid-gas separator for separating gas from the oil, oil recovery formulation, and water; and a conventional hydrocarbon-water separator including a demulsification unit for separating the oil from water and water soluble components of the oil recovery formulation.

The separated produced oil may be provided from the separation unit 267 of the second injection/production facility 259 to an oil storage tank 269, which may be fluidly operatively coupled to the separation unit 267 of the second injection/production facility by conduit 271. The separated gas, if any, may be provided from the separation unit 267 of the second injection/production facility 259 to the gas storage tank 263, which may be fluidly operatively coupled to the separation unit 267 of the second injection/production facility 259 by conduit 273.

In an embodiment of a system and a method of the present invention, the first well 201 may be used for injecting the oil recovery formulation and/or its components into the formation 205 and the second well 203 may be used to produce oil from the formation as described above for a first time period, and the second well 203 may be used for injecting the oil recovery formulation and/or its components into the formation 205 to mobilize the oil in the formation and drive the mobilized oil across the formation to the first well and the first well 201 may be used to produce oil from the formation for a second time period, where the second time period is subsequent to the first time period. The second injection/production facility 259 may comprise a mechanism such as pump 275 that may be fluidly operatively coupled the oil recovery formulation storage facility 219 by conduit 277, and that is fluidly operatively coupled to the second well 203 to introduce the oil recovery formulation into the formation 205 via the second well. Alternatively, as shown in FIG. 2, the mechanism 275 may be fluidly operatively coupled to: the ammonia liquid storage facility 227 via conduit 279; the surfactant storage facility 229 via conduit 281; and the polymer storage facility 231 by conduit 283 for introduction of the components of the oil recovery formulation into the formation via the second well 203. Referring again to FIGS. 1 and 2, the first injection/production facility 221 may comprise a mechanism such as pump 285, or compressor 287 fluidly operatively coupled to the gas storage tank 263 by conduit 289, for production of oil, and optionally the oil recovery formulation, water, and/or gas from the formation 205 via the first well 201. The first injection/production facility 221 may also include a separation unit 291 for separating produced oil, oil recovery formulation, water, and/or gas. The separation unit 291 may be comprised of a conventional liquid-gas separator for separating gas from the produced oil and water; and a conventional hydrocarbon-water separator for separating the produced oil from water and water soluble components of the oil recovery formulation, where the hydrocarbon-water separator may comprise a demulsifier. The separation unit 291 may be fluidly operatively coupled to: the oil storage tank 269 by conduit 293 for storage of produced oil in the oil storage tank; and the gas storage tank 263 by conduit 295 for storage of produced gas in the gas storage tank.

The first well 201 may be used for introducing the oil recovery formulation or the components of the oil recovery formulation into the formation 205 and the second well 203 may be used for producing oil from the formation for a first time period; then the second well 203 may be used for introducing the oil recovery formulation or components of the oil recovery formulation into the formation 205 and the first well 201 may be used for producing oil from the formation for a second time period; where the first and second time periods comprise a cycle. Multiple cycles may be conducted which include alternating the first well 201 and the second well 203 between introducing the oil recovery formulation or its components into the formation 205 and producing oil from the formation, where one well is introducing and the other is producing for the first time period, and then they are switched for a second time period. A cycle may be from about 12 hours to about 1 year, or from about 3 days to about 6 months, or from about 5 days to about 3 months.

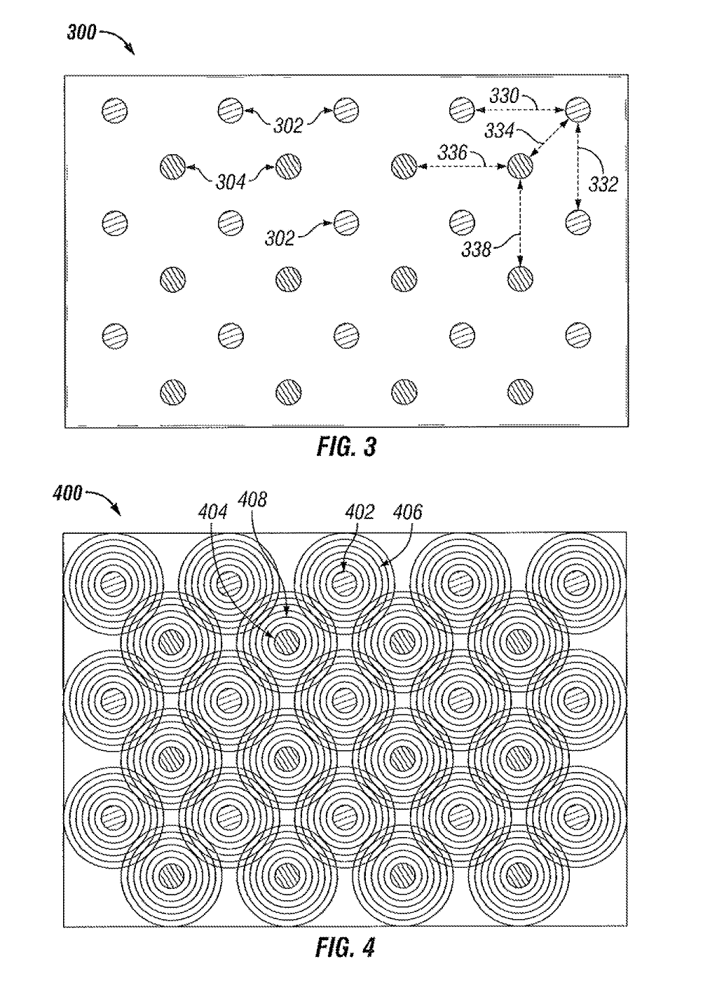

Referring now to FIG. 3, an array of wells 300 is illustrated. Array 300 includes a first well group 302 (denoted by lines slanting upwards from left to right) and a second well group 304 (denoted by lines slanting downwards from left to right). In some embodiments of the system and method of the present invention, the first well of the system and method described above may include multiple first wells depicted as the first well group 302 in the array 300, and the second well of the system and method described above may include multiple second wells depicted as the second well group 304 in the array 300.

Each well in the first well group 302 may be a horizontal distance 330 from an adjacent well in the first well group 302. The horizontal distance 330 may be from about 5 to about 5000 meters, or from about 10 to about 1000 meters, or from about 20 to about 500 meters, or from about 30 to about 250 meters, or from about 50 to about 200 meters, or from about 90 to about 150 meters, or about 100 meters. Each well in the first well group 302 may be a vertical distance 332 from an adjacent well in the first well group 302. The vertical distance 332 may be from about 5 to about 5000 meters, or from about 10 to about 1000 meters, or from about 20 to about 500 meters, or from about 30 to about 250 meters, or from about 50 to about 200 meters, or from about 90 to about 150 meters, or about 100 meters.

Each well in the second well group 304 may be a horizontal distance 336 from an adjacent well in the second well group 304. The horizontal distance 336 may be from 5 to 5000 meters, or from 10 to 1000 meters, or from 20 to 500 meters, or from 30 to 250 meters, or from 50 to 200 meters, or from 90 to 150 meters, or about 100 meters. Each well in the second well group 304 may be a vertical distance 338 from an adjacent well in the second well group 304. The vertical distance 338 may be from 5 to 5000 meters, or from 10 to about 1000 meters, or from 20 to 500 meters, or from 30 to 250 meters, or from 50 to 200 meters, or from 90 to 150 meters, or about 100 meters.

Each well in the first well group 302 may be a distance 334 from the adjacent wells in the second well group 304. Each well in the second well group 304 may be a distance 334 from the adjacent wells in first well group 302. The distance 334 may be from 5 to 5000 meters, or from 10 to 1000 meters, or from 20 to 500 meters, or from 30 to 250 meters, or from 50 to 200 meters, or from 90 to 150 meters, or about 100 meters.

Each well in the first well group 302 may be surrounded by four wells in the second well group 304. Each well in the second well group 304 may be surrounded by four wells in the first well group 302.

In some embodiments, the array of wells 300 may have from 10 to 1000 wells, for example from 5 to 500 wells in the first well group 302, and from 5 to 500 wells in the second well group 304.

In some embodiments, the array of wells 300 may be seen as a top view with first well group 302 and the second well group 304 being vertical wells spaced on a piece of land. In some embodiments, the array of wells 300 may be seen as a cross-sectional side view of the formation with the first well group 302 and the second well group 304 being horizontal wells spaced within the formation.

Referring now to FIG. 4, an array of wells 400 is illustrated. Array 400 includes a first well group 402 (denoted by lines slanting upwards from left to right) and a second well group 404 (denoted by lines slanting downwards from left to right). The array 400 may be an array of wells as described above with respect to array 300 in FIG. 3. In some embodiments of the system and method of the present invention, the first well of the system and method described above may include multiple first wells depicted as the first well group 402 in the array 400, and the second well of the system and method described above may include multiple second wells depicted as the second well group 404 in the array 400.

The oil recovery formulation or components thereof may be injected into first well group 402 and oil may be recovered and produced from the second well group 404. As illustrated, the oil recovery formulation may have an injection profile 406, and oil may be produced from the second well group 404 having a oil recovery profile 408.

The oil recovery formulation or components thereof may be injected into the second well group 404 and oil may be produced from the first well group 402. As illustrated, the oil recovery formulation may have an injection profile 408, and oil may be produced from the first well group 402 having an oil recovery profile 406.

The first well group 402 may be used for injecting the oil recovery formulation or components thereof and the second well group 404 may be used for producing oil from the formation for a first time period; then second well group 404 may be used for injecting the oil recovery formulation or components thereof and the first well group 402 may be used for producing oil from the formation for a second time period, where the first and second time periods comprise a cycle. In some embodiments, multiple cycles may be conducted which include alternating first and second well groups 402 and 404 between injecting the oil recovery formulation or components thereof and producing oil from the formation, where one well group is injecting and the other is producing for a first time period, and then they are switched for a second time period.

To facilitate a better understanding of the present invention, the following examples of certain aspects of some embodiments are given. In no way should the following examples be read to limit, or define, the scope of the invention.

### EXAMPLE

An oil recovery flood in accordance with the method and system of the present invention utilizing a composition in accordance with the present invention was performed. An experiment was conducted to determine the effect of utilizing an ammonia-surfactant-polymer formulation on residual oil recovery from a formation. A sandpack was prepared by packing an 80 to 120 mesh sand in a two inch diameter glass cylinder. The sandpack was then put under vacuum and flooded with a synthetic reservoir brine solution. The sandpack was then positioned vertically in an oven at 69° C., and saturated with a low viscosity (1.2 mPa s at 69° C.) crude oil from the top of the sandpack until no more water was produced upon further introduction of oil to the sandpack. To simulate water flood production of oil from the sandpack, the sandpack was then flooded with the synthetic brine solution from the bottom of the sandpack at a rate of 1.0 meter/day until no more oil was produced from the sandpack. By these techniques both oil saturation and waterflood are stabilized by gravity as the less dense fluid is injected from the top of the sandpack and the more dense fluid is injected from the bottom. The amount of residual oil remaining in the sandpack after the waterflood (Sor) was calculated by subtracting the amount of oil recovered as a result of the waterflood from the total amount of oil absorbed by the sandpack during saturation of the sandpack with oil.

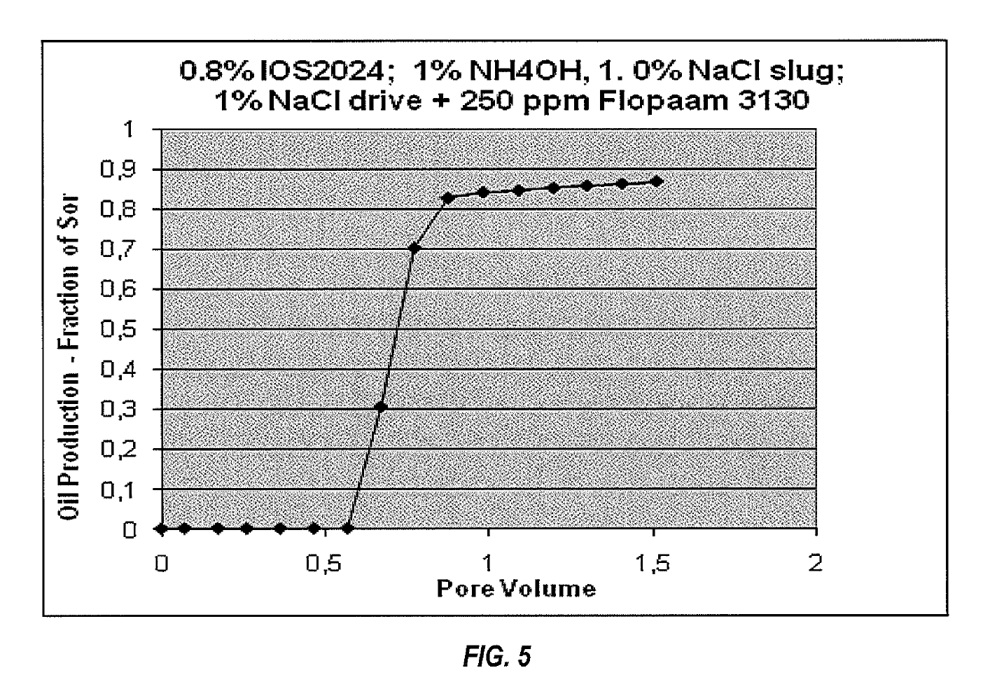

Oil recovery resulting from an ammonia-surfactant-polymer flood was then determined. An ammonia-surfactant-polymer brine solution was prepared containing 1 wt. % NH₄OH, 0.8 wt. % IOS2024 as the surfactant (C20 to 24 internal olefin sulfonate), 250 ppm FLOPAAM 3130 (a copolymer of 30% acrylic acid and 70% acrylamide, nominally 5 million molecular weight), and 1 wt. % NaCl. To determine the oil recovery resulting from an ammonia-surfactant-polymer flood after the waterflood, the sandpack was flooded with 0.3 pore volumes of the ammonia-surfactant-polymer brine solution at a flow rate of 1 foot/day followed by 1.2 pore volumes of 250 ppm FLOPAAM 3130 in 1% NaCl to produce further oil from the residual oil remaining in the sandpack. Referring to FIG. 5, the oil production of the residual oil (S_{OR}) was graphed as a function of the pore volumes of the ammonia-surfactant-polymer brine solution introduced to the sandpack. As shown in FIG. 5, introduction of 0.3 pore volumes of ammonia-surfactant-polymer brine solution and 1.2 pore volumes of polymer solution to the sandpack provided approximately 87% recovery of the residual oil in the sandpack.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While systems and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range also includes any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

What is claimed is:

1. A process for recovering oil from an oil-bearing formation, comprising:
mixing a surfactant, water, a polymer, and ammonia liquid comprising at most 10 wt. % water to form an oil recovery formulation;
introducing the oil recovery formulation into the oil-bearing formation;
contacting the oil recovery formulation with oil in the oil-bearing formation; and
producing oil from the oil-bearing formation after introduction of the oil recovery formulation into the oil-bearing formation.

2. The process of claim 1 wherein the ammonia liquid mixed with the surfactant, the polymer, and the water comprises from 0.01 wt. % to 5 wt. % of the total weight of the combined ammonia liquid, surfactant, polymer, and water.

3. The process of claim 1 wherein the ammonia liquid is anhydrous liquid ammonia.

4. The process of claim 1 wherein the water has a total dissolved solids content of from 200 ppm to 100000 ppm.

5. The process of claim 1, wherein the surfactant is an anionic surfactant.

6. The process of claim 5 wherein the anionic surfactant is selected from the group consisting of an alpha olefin sulfonate compound, an internal olefin sulfonate compound, a branched alkyl benzene sulfonate compound, a propylene oxide sulfate compound, an ethylene oxide sulphate compound, an ethylene-propylene oxide sulfate compound, or a blend thereof.

7. The process of claim 1 wherein the polymer is selected from the group consisting of polyacrylamides; partially hydrolyzed polyacrylamides; copolymers of acrylamide, acrylic acid, AMPS (2-acrylamide-,methyl propane sulfonate) and n-vinylpyrrolidone in any ratio; polyacrylates; ethylenic co-polymers; biopolymers; carboxymethylcelloluses; polyvinyl alcohols; polystyrene sulfonates; polyvinylpyrrolidones; AMPS; and combinations thereof.

8. The process of claim 1 wherein the oil recovery formulation comprises from 0.05 wt. % to 5 wt. % of the surfactant, from 200 ppm to 10000 ppm of the polymer, and from 0.01 wt. % to 5 wt. % of the ammonia liquid.

9. The process of claim 1 wherein the oil-bearing formation is a subterranean formation.

10. The process of claim 9 wherein the oil-bearing formation is a subsea formation.

11. The process of claim 1 wherein the oil recovery formulation has a dynamic viscosity within 400% of the dynamic viscosity of oil of the oil-bearing formation when measured isothermally.

12. A composition comprising a mixture of a surfactant, a polymer, ammonia, and water.

13. The composition of claim 12 wherein the ammonia comprises from 0.01 wt. % to 5 wt. % of the composition.

14. The composition of claim 12 wherein the surfactant is an anionic surfactant.

15. The composition of claim 12 wherein the polymer is selected from the group consisting of polyacrylamides; partially hydrolyzed polyacrylamides; copolymers of acrylamide, acrylic acid, AMPS (2-acrylamide-methyl propane sulfonate) and n-vinylpyrrolidone in any ratio; polyacrylates; ethylenic co-polymers; biopolymers; carboxymethylcelluloses; polyvinyl alcohols; polystyrene sulfonates; polyvinylpyrrolidones; AMPS; and combinations thereof.

16. The composition of claim 12 wherein the composition comprises from 0.05 wt. % to 5 wt. % of the surfactant, from 200 ppm to 10000 ppm of the polymer, and from 0.01 wt. % to 5 wt. % of the ammonia.

17. A system, comprising:
a surfactant;
a polymer;
an ammonia liquid comprising at most 10 wt. % water;
water;
an oil-bearing formation;
a mechanism for introducing the surfactant, the polymer, the ammonia liquid and the water into the oil-bearing formation; and
a mechanism for producing oil from the oil-bearing formation subsequent to introduction of the aqueous oil recovery formulation into the oil-bearing formation.

18. The system of claim 17 further comprising a mechanism for mixing the surfactant, the polymer, the ammonia liquid, and the water to form an oil recovery formulation, wherein the mechanism for introducing the surfactant, the polymer, the ammonia liquid, and the water into the oil-bearing formation is a mechanism for introducing the oil recovery formulation into the oil-bearing formation.

19. The system of claim 18 wherein the oil recovery formulation comprises from 0.01 wt. % to 5 wt. % of the ammonia liquid.

20. The system of claim 17 wherein the oil-bearing formation is a subsea formation.

21. The system of claim 17 further comprising:
a platform located on the surface of a sea located above the subsea formation;
a storage facility for storing the surfactant located on the platform;
a storage facility for storing the polymer located on the platform; and
a storage facility for storing the ammonia liquid located on the platform.

22. The system of claim 17 wherein the mechanism for introducing the surfactant, the polymer, the ammonia liquid, and the water into the formation is located at a first well extending into the formation.

23. The system of claim 22 wherein the mechanism for producing oil from the formation is located at a second well extending into the formation.

24. The system of claim 17 wherein the ammonia liquid is anhydrous liquid ammonia.

25. A process for recovering oil from an oil-bearing formation, comprising:
introducing a surfactant, water, a polymer, and an ammonia liquid containing at most 10 wt. % water into the oil-bearing formation;
mixing the surfactant, water, polymer, and ammonia liquid in the oil-bearing formation to form an oil recovery formulation;
contacting the oil recovery formulation with oil in the oil-bearing formation; and
producing oil from the oil bearing-formation after introduction of the surfactant, water, polymer and ammonia liquid into the oil-bearing formation.

26. The process of claim 25 wherein the amount of ammonia liquid introduced into the formation is from 0.5 wt. % to 2 wt. % of the total combined weight of the ammonia liquid, the water, the surfactant, and the polymer introduced into the formation.

27. The process of claim 25 wherein the ammonia liquid is liquid anhydrous ammonia.

28. The process of claim 25 wherein the water has a total dissolved solids content of from 200 ppm to 100000 ppm.

29. The process of claim 25 wherein the surfactant is an anionic surfactant.

30. The process of claim 29 wherein the anionic surfactant is selected from the group consisting of an alpha olefin sulfonate compound, an internal olefin sulfonate compound, a branched alkyl benzene sulfonate compound, a propylene oxide sulfate compound, an ethylene oxide sulphate compound, an ethylene-propylene oxide sulfate compound, or a blend thereof.

31. The process of claim 25 wherein the polymer is selected from the group consisting of polyacrylamides; partially hydrolyzed polyacrylamides; copolymers of acrylamide, acrylic acid, AMPS (2-acrylamide-,methyl propane sulfonate) and n-vinylpyrrolidone in any ratio; polyacrylates; ethylenic co-polymers; biopolymers; carboxymethylcelluloses; polyvinyl alcohols; polystyrene sulfonates; polyvinylpyrrolidones; AMPS; and combinations thereof.

32. The process of claim 25 wherein the oil recovery formulation comprises from 0.05 wt. % to 5 wt. % of the surfactant, from 250 ppm to 10000 ppm of the polymer, and from 0.01 wt. % to 5 wt. % of the ammonia liquid.

33. The process of claim 25 wherein the oil-bearing formation is a subterranean formation.

34. The process of claim 33 wherein the oil-bearing formation is a subsea formation.

35. The process of claim 25 wherein the oil recovery formulation has a dynamic viscosity within 400% of the dynamic viscosity of oil of the oil-bearing formation when measured isothermally.
